(19) United States
(12) Patent Application Publication
(10) Pub. No.: US 2025/0148359 A1
(43) Pub. Date: May 8, 2025

(54) GENERATING INFORMED PRIORS FOR HYPERPARAMETER SELECTION

(71) Applicant: Microsoft Technology Licensing, LLC, Redmond, WA (US)

(72) Inventors: Laurent BOUÉ, Petah Tikva (IL); Swarnim NARAYAN, Bangalore (IN); Kiran RAMA, Bangalore (IN)

(21) Appl. No.: 18/504,333

(22) Filed: Nov. 8, 2023

(51) Int. Cl. G06N 20/00

(52) U.S. Cl. CPC G06N 20/00

(57) ABSTRACT

A system iteratively evaluates the target machine learning model using evaluation hyperparameter values of the target machine learning model to measure performance of the target machine learning model for different combinations of the evaluation hyperparameter values. The system trains a surrogate machine learning model using the different combinations of the evaluation hyperparameter values as features and the performance of the target machine learning model based on a corresponding combination of the evaluation hyperparameter values as labels. The system generates a feature importance vector of the surrogate machine learning model based on the training of the surrogate machine learning model, generate informed priors based on the feature importance vector, and generates the target hyperparameter values of the target machine learning model based on the informed priors.

### BACKGROUND

Generally, hyperparameters (e.g., relating to architectural complexity and algorithm hyperparameters) are adjustable parameters that influence the performance of a machine learning model (MLM). In contrast to internal parameters of a model, such as coefficients (or weights) of linear and logistic regression models, weights and biases of a neural network, and cluster centroids in clustering, which are trained during a training process, hyperparameters define structural and algorithmic characteristics of a machine learning model but are not trained during a machine learning (ML) training process. For example, a neural network designer decides the number of hidden layers and the number of nodes in each layer. For another example, XGBoost is an open-source software library that implements machine learning algorithms under the Gradient Boosting framework and can include a number of hyperparameters, such as the number of trees, the maximum depth of a tree, learning rate, regularization parameters, and the number of distinct classes for a classification problem. In various implementations, hyperparameters may be discrete and/or continuous and have a distribution of values described by a hyperparameter expression. The performance of a machine learning model depends heavily on its hyperparameters.

### SUMMARY

In some aspects, the techniques described herein relate to a method of generating target hyperparameter values of a target machine learning model, the method including: iteratively evaluating the target machine learning model using evaluation hyperparameter values of the target machine learning model to measure performance of the target machine learning model for different combinations of the evaluation hyperparameter values, training a surrogate machine learning model using the different combinations of the evaluation hyperparameter values as features and the performance of the target machine learning model based on a corresponding combination of the evaluation hyperparameter values as labels; generating a feature importance vector of the surrogate machine learning model based on the training of the surrogate machine learning model; generating informed priors based on the feature importance vector; and generating the target hyperparameter values of the target machine learning model based on the informed priors.

In some aspects, the techniques described herein relate to a system for generating target hyperparameter values of a target machine learning model, the system including: one or more hardware processors; an untuned model evaluator executable by the one or more hardware processors and being configured to iteratively evaluate the target machine learning model using evaluation hyperparameter values of the target machine learning model to measure performance of the target machine learning model for different combinations of the evaluation hyperparameter values, a surrogate model trainer executable by the one or more hardware processors and being configured to train a surrogate machine learning model using the different combinations of the evaluation hyperparameter values as features and the performance of the target machine learning model based on a corresponding combination of the evaluation hyperparameter values as labels; a feature importance extractor executable by the one or more hardware processors and being configured to generate a feature importance vector of the surrogate machine learning model based on the training of the surrogate machine learning model; a probability distribution parameterizer executable by the one or more hardware processors and being configured to generate informed priors based on the feature importance vector; and a hyperparameter tuner executable by the one or more hardware processors and being configured to generate the target hyperparameter values of the target machine learning model based on the informed priors using Bayesian optimization.

In some aspects, the techniques described herein relate to one or more tangible processor-readable storage media embodied with instructions for executing on one or more processors and circuits of a computing device a process for generating target hyperparameter values of a target machine learning model, the process including: iteratively evaluating the target machine learning model using evaluation hyperparameter values of the target machine learning model to measure performance of the target machine learning model for different combinations of the evaluation hyperparameter values, training a surrogate machine learning model using the different combinations of the evaluation hyperparameter values as features and the performance of the target machine learning model based on a corresponding combination of the evaluation hyperparameter values as labels; generating a feature importance vector of the surrogate machine learning model based on the training of the surrogate machine learning model; generating informed priors based on the feature importance vector; and generating the target hyperparameter values of the target machine learning model based on the informed priors using Bayesian optimization.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example system for generating tuned hyperparameter values for a tuned machine learning model.

FIG. 2 illustrates an example system for generating informed priors.

FIG. 3 illustrates an example system for training a surrogate machine learning model that predicts the importance of hyperparameters of a target machine learning model.

FIG. 4 illustrates an example system for converting a feature importance vectors of a surrogate machine learning model to informed priors useful in hyperparameter tuning for a target machine learning model.

FIG. 5 illustrates example operations for generating target hyperparameter values of a target machine learning model.

FIG. 6 illustrates an example computing device for use in implementing the described technology.

### DETAILED DESCRIPTIONS

Searching for optimal or acceptable combinations of hyperparameters is a highly resource-intensive task as such searches can inherently be trial-and-error processes in which one needs to train and evaluate the target models many times over very large datasets. Example approaches to determining hyperparameters include random choices, grid searches, and Bayesian optimization.

Bayesian optimization is a probabilistic approach to search for hyperparameters that works by refining its search strategy as more hyperparameter combinations and the resulting model performances are evaluated. Bayesian optimization usually involves assuming a probability distribution for each hyperparameter, and the candidate hyperparameter values are sampled from those distributions over multiple iterations. Bayesian optimization typically employs one or more prior probability distributions of uncertain quantities. The prior probability distributions are often referred to as “priors” (also known as “prior beliefs” or “initial guesses”) and represent assumed probability distributions of the uncertain quantity before some evidence is taken into account. For example, the prior could be the (unknown) probability distribution representing the relative proportions of voters who will vote for a particular politician in a future election.

Typically, “uninformed” priors for hyperparameter optimization are deliberately set to be broad and non-specific to avoid introducing any preconceived biases that might mislead the optimization process. The rationale is that uninformed priors allow the optimization algorithm to explore a wide range of hyperparameter configurations at the beginning, preventing it from prematurely focusing on a narrow portion of the search space. Obviously, the breadth of this conservative approach comes at a tremendous computational cost, as little or no prior information is taken into consideration to help guide the search. Thus, the search can take a long time to find the resulting hyperparameters.

A technical benefit of the technology described herein is that the search for determining hyperparameters for a target machine learning model can be focused or guided by replacing uninformed priors with “informed priors” and, therefore, use fewer computer resources and take less time than with broader searching using uninformed priors. In various implementations, the informed priors are generated based on feature importance vectors of a machine learning model trained on samples of hyperparameter values (e.g., features) and the performance of the target machine learning model executed on a representative or reduced set of the training data of the target machine learning model.

In the described technology, an automated and data-efficient method establishes an association between the set of hyperparameters and a set of scores. Those scores are combined to produce a prior belief that maximizes or enhances the informative value of each hyperparameter for a specific training dataset and target machine learning model. By doing so, the described method provides an alternative for the costly default exploration phase of current Bayesian optimization frameworks reliant on uninformed priors. The resultant set of hyperparameters generated through the described technology is poised to provide faster convergence toward an ultimate optimal hyperparameter configuration.

Furthermore, the list below provides a non-exhaustive list of example use cases where the described technology can be applied:
Universal applicability to custom MLM development—the described technology reduces the time and cost of tuning hyperparameters for any ML model, with the extent of tuning varying from minimal to full-fledged last-mile optimization based on the use case involved.
Auto-ML companies that provide hyperparameter tuning for client models—the described technology can enable such providers to achieve this faster and with fewer computing and storage resources.
Cloud vendors that provide services to clients that have to be optimized for each of the client use cases—the reduced time and resource requirements of the described technology can make such optimizations available on a more real-time basis.

The term “hyperparameter” (without the term “value”) indicates the variable corresponding to a hyperparameter, such as the variable corresponding to the number of layers in a neural network. In contrast, the term “hyperparameter value” the value of the hyperparameter, such that the actual number of layers in the neural network is referred to as a hyperparameter value. Other example hyperparameters may include without limitation the number of trees in neural network, and an example of that hyperparameter value might be 10 (i.e., 10 trees in the neural network).

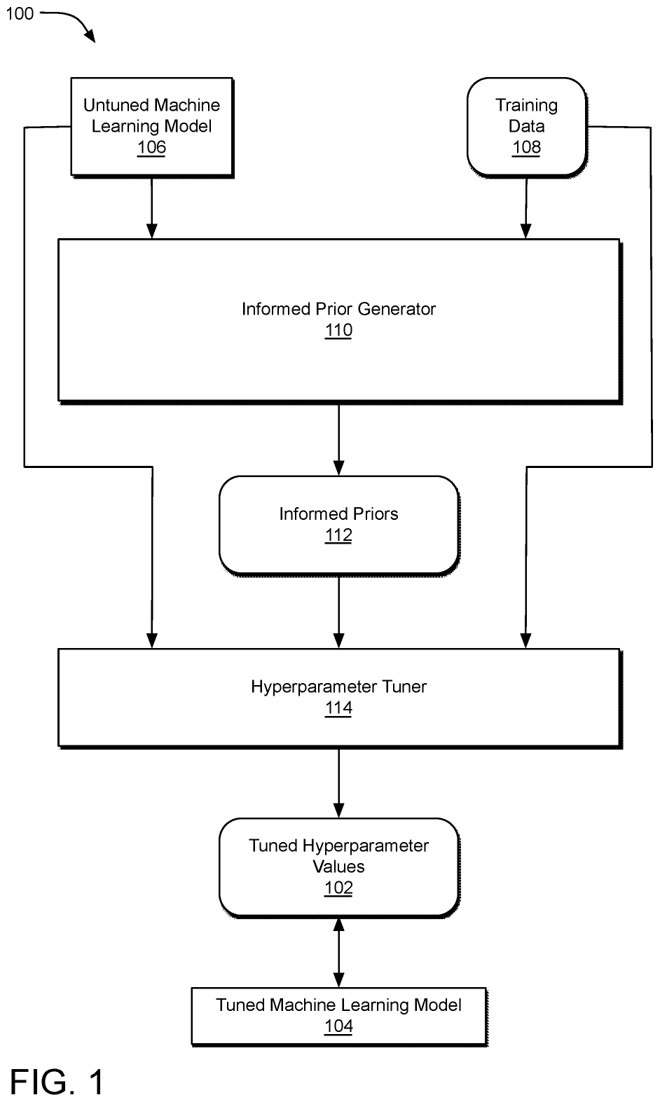

FIG. 1 illustrates an example system 100 for generating tuned hyperparameter values 102 for a tuned machine learning model 104. Developing appropriate hyperparameters for the tuned machine learning model 104 can be a time-consuming and resource-intensive task. The described technology reduces the time and resources needed to generate the tuned hyperparameter values 102 by narrowing or focusing the dataset from which initial prior probability distributions may be selected for use in a Bayesian optimization, which can be used to tune hyperparameters for a machine learning model. For example, by narrowing the dataset from which initial prior probability distributions may be selected for Bayesian optimization, a tuning system can find a minimal point of some objective function more quickly than when a broader set of possible prior probability distributions is used.

An untuned machine learning model 106 represents a target machine learning model that lacks at least one tuned hyperparameter, although untuned machine learning model 106 typically does not include any tuned hyperparameters. Training data 108 represents a set of training data (e.g., a set of medical scan images plus corresponding diagnosis labels) intended for use in training the untuned machine learning model 106 for a particular application.

Bayesian optimization, which can be used to generate the tuned hyperparameter values 102 of a machine learning model, employs prior probability distributions in its optimization iterations. Prior to the generation of informed priors by an informed prior generator 110, these prior probability distributions are considered uninformed priors because they have not yet been focused by the informed prior generator. Bayesian optimization of tuned hyperparameter values 102 using uninformed priors would require more time and/or computing resources than Bayesian optimization of tuned hyperparameter values 102 using informed priors, in part because a large number of initial optimization parameters (priors) have been narrowed to reduce the number of iterations needed to tune the hyperparameters.

The untuned machine learning model 106 and the training data 108 are input to an informed prior generator 110 to generate informed priors 112 (informed prior probability distributions). The informed priors 112 are determined, in part, from sampled hyperparameter values based on a feature importance vector of a machine learning model trained on samples of hyperparameter values (e.g., features) and the performance of the target machine learning model executed on a representative or reduced set of the training data of the target machine learning model. In one implementation, the set of sampled hyperparameter values is selected for use with the surrogate machine learning model from a set of allowable hyperparameter values, such as values selected from a convex hull. A set of points in a Euclidean space is defined to be convex if it contains the line segments connecting each pair of its points. As such, a convex hull may be defined either as the intersection of all convex sets containing a given subset of a Euclidean space or, equivalently, as the set of all convex combinations of points in the subset.

The informed priors are input to a hyperparameter tuner 114 that generates tuned hyperparameter values 102, such as through Bayesian optimization or another tuning technique that employs prior probability distributions. The tuned hyperparameter values 102 are then applied to the untuned machine learning model 106 to yield a tuned machine learning model 104.

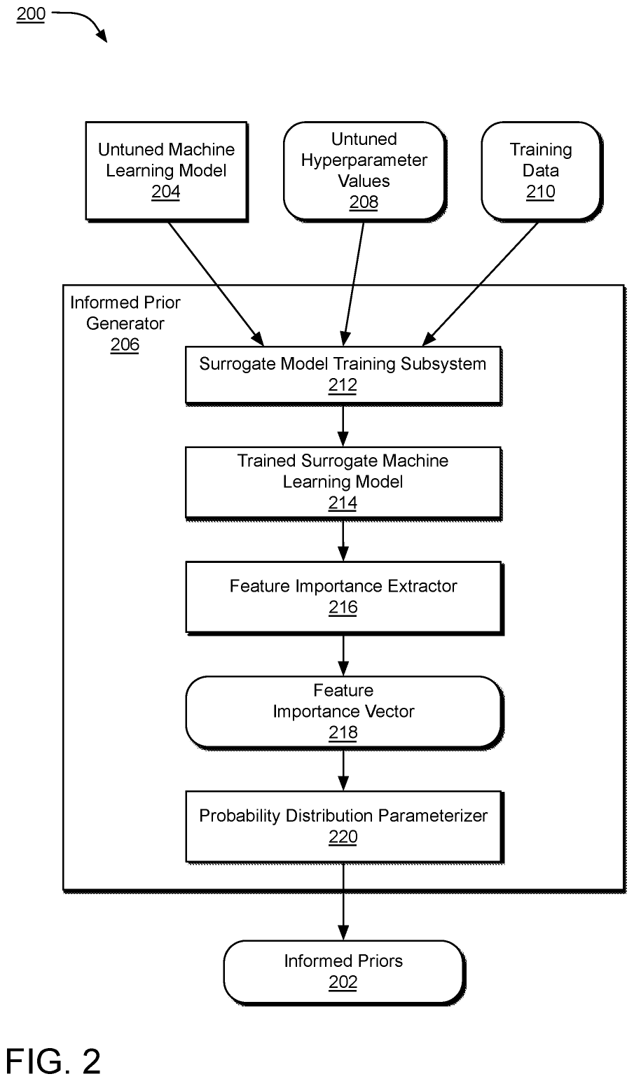

FIG. 2 illustrates an example system 200 for generating informed priors 202. An untuned machine learning model 204 is input to an informed prior generator 206 and represents a version of a target machine learning model that has not been partially or fully tuned. For example, one or more values of the hyperparameters of the untuned machine learning model 204 have not been tuned (e.g., via Bayesian optimization or some other tuning technique) or are deemed to be no longer tuned.

Untuned hyperparameter values 208 are input to the informed prior generator 206 and represent allowable hyperparameter values for the target machine learning model, typically with some level of applied constraint. For example, the number of layers in a neural network is designated as being a positive number, so the corresponding hyperparameter would be constrained as positive. Furthermore, in some implementations of the described technology, the untuned hyperparameter values 208 are constrained as residing on a convex hull, as described in more detail below.

Training data 210 are input to the informed prior generator 206 and represent training data collected for use in training the target machine learning model. In some implementations of the described technology, the set of the training data 210 is reduced in size for use in training a surrogate machine learning model.

The untuned machine learning model 204, the untuned hyperparameter values 208, and the training data 210 are input to a surrogate model training subsystem 212, which trains the surrogate machine learning model, typically with a constrained set of the untuned hyperparameter values 208 (e.g., constrained to values on a convex hull) and a reduced dataset of the training data 210. In this manner, the training of the surrogate machine learning model need not search over such a broad set of hyperparameter values and/or train over a complete set of training data, both of which can be very time and resource-intensive.

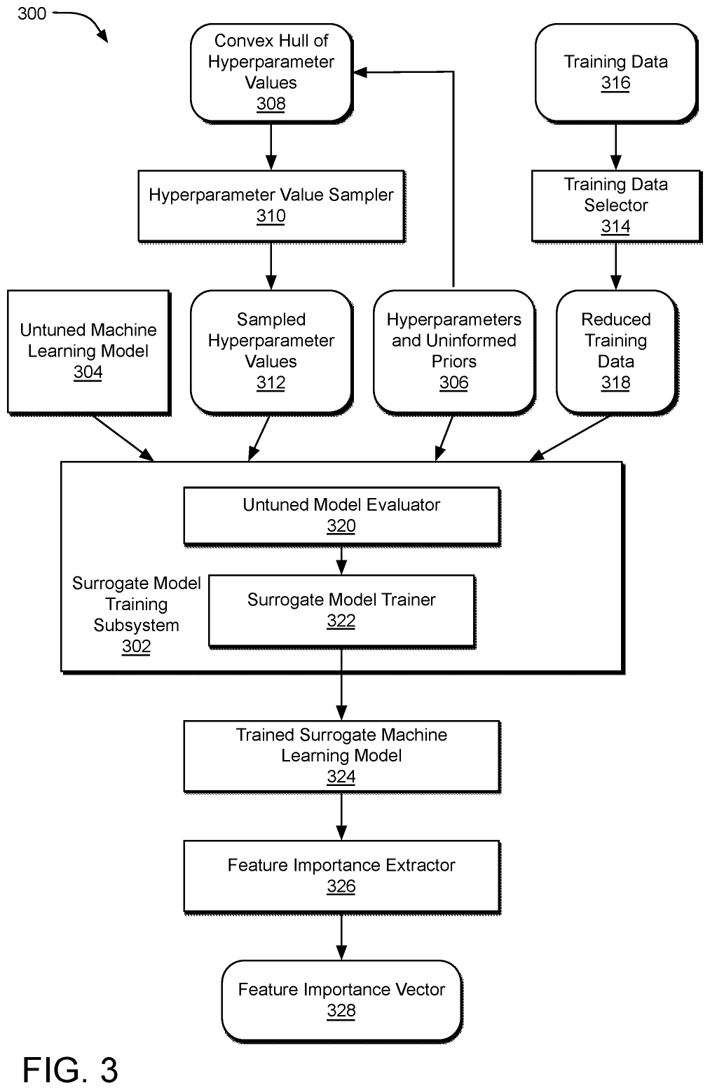

The surrogate model training subsystem 212, described in more detail with respect to FIG. 3, outputs a trained surrogate machine learning model 214. A feature importance extractor 216 extracts a feature importance vector 218 from the trained surrogate machine learning model 214. A probability distribution parameterizer 220 generates the informed priors 202 from the feature importance vector 218.

In probability and statistics, the Dirichlet distribution is often denoted as Dir(alpha) or Dir(α) and represents a family of continuous multivariate probability distributions parameterized by a vector α of positive real numbers. The Dirichlet distribution is a multivariate generalization of the beta distribution and can be referred to by its alternative name of multivariate beta distribution (MBD). Dirichlet distributions are commonly used as prior distributions in Bayesian statistics. In some aspects, the Dirichlet distribution is the conjugate prior to the categorical distribution and multinomial distribution.

FIG. 3 illustrates an example system 300 for training a surrogate machine learning model that predicts the importance of hyperparameters of a target machine learning model. A surrogate model training subsystem 302 receives an untuned version of the target machine learning model (see untuned machine learning model 304) as input. A set of hyperparameters for the target machine learning model and their associated uninformed prior probability distributions (see hyperparameters and uninformed priors 306) are also input to the surrogate model training subsystem 302. The hyperparameters represent the various adjustable parameters used in the design of the target machine learning model, the values of which have not yet been tuned prior to input to the surrogate model training subsystem 302. The uninformed priors represent the prior probability distributions of these hyperparameters, and these priors have also not yet been tuned prior to input to the surrogate model training subsystem 302.

A distribution of allowable hyperparameter values corresponding to the hyperparameters referenced in the hyperparameters and uninformed priors 306 are defined on a convex hull of hyperparameter values 308. These hyperparameters may also be constrained by other factors (e.g., the number of layers in a neural network is positive). In some implementations, the priors may be set within a range of minimum and maximum values expected for each hyperparameter and then constructed into a convex hull of hyperparameters prescribed by those extreme values. Convexity represents that for any two points within the shape, all points along the straight line connecting them are also inside the shape.

The convex hull of hyperparameter values 308 effectively defines the hyperparameter search space. In one implementation, the sampled hyperparameter values 312 create discrete combinations of hyperparameters to tile the search space defined by the convex hull. This approach can be implemented by defining a probability distribution over the convex hull and sample Nₑᵥₐₗᵤₐₜᵢₒₙ hyperparameter combinations from it. Accordingly, a hyperparameter value sampler 310 samples hyperparameter values from the convex hull of hyperparameter values 308 to yield sampled hyperparameter values 312, which is smaller than the set of all possible hyperparameter values 312 on the hyperparameter values 308. Note that other implementations may potentially use other space partitioning constructions and/or sampling techniques.

A training data selector 314 receives, as input, training data 316 and selects a proper subset of the training data 316 to yield a representative training dataset (reduced training data 318) of the fuller training dataset, such that the number of training data samples N_{reduced} in the reduced training data 318 is significantly fewer than the number of samples N in the training data 316 (e.g., N_{reduced}<<N). The reduced training data 318 is input to the surrogate model training subsystem 302. The reduction in training data may be performed by random sampling of the training data 316, although other techniques may also be employed, such as sub-sampling in a stratified manner based on feature/label combinations.

An untuned model evaluator 320 of the surrogate model training subsystem 302 trains untuned machine learning model 304 using the reduced training data 318 (N_{reduced}), yielding a partially-trained target machine learning model, and iteratively evaluates the partially-trained target machine learning model using multiple combinations of hyperparameters selected from the sampled hyperparameter values 312. The evaluations result in the following output, in one implementation:
N_{hyperparameter_1}, performance of the target model in the first evaluation
N_{hyperparameter_2}, performance of the target model in the second evaluation
N_{hyperparameter_3}, performance of the target model in the third evaluation
N_{hyperparameter_J}, performance of the target model in the last evaluation
   where the combinations of hyperparameters used in these evaluations are designated by N_{hyperparameter_j}, hyperparameter_j is an index of hyperparameter combination used in the jth evaluation, and performance of the target model is measured using an example performance measurement, including without limitation loss value, F1 score (the F1 score is the harmonic mean of the precision and recall and symmetrically represents both precision and recall in one metric), AUC-area under the ROC (receiver operating characteristic) curve, and accuracy. The metrics used in any given scenario may be determined by domain experts to correspond best to a designated objective or characteristic. In summary, the untuned model evaluator 320 trains multiple versions of the untuned machine learning model 304 (multiple versions as in different combinations of hyperparameters used) on reduced subsets of the training data 316, saves both time and computational cost and enabling quicker convergence.

A surrogate model trainer 322 of the surrogate model training subsystem 302 trains a surrogate machine learning model to predict a performance metric of the target machine learning model using hyperparameter combinations j=1 to J, wherein J is the number of hyperparameters for the target machine learning model. Because the performance of the target machine learning model would typically be measured using a real value, the surrogate machine learning model may be implemented as a regression task where the features are the hyperparameter value combinations of the indexed versions of the target machine learning model, and the label is the performance of the corresponding version of the target machine learning model (as evaluated on the Nₑᵥₐₗᵤₐₜᵢₒₙ combinations of hyperparameters). In summary, the surrogate machine learning model predicts the performance metric based on the combination of the hyperparameter values used. The surrogate model trainer 322 outputs a trained surrogate machine learning model 324.

A feature importance extractor 326 extracts a feature importance vector 328 from the trained surrogate machine learning model 324 using an explanation technique. In one implementation, an explanation tool, such as SHAP (SHapley Additive explanations), LIME (Local Interpretable Model-agnostic Explanations), or some other kind of permutation test. SHAP, for example, assists in interpreting machine learning models with Shapely values, which are measures of the contributions each feature (predictor) has in a machine learning model. In one view, Shapely values are measures of how important a specific feature is to the predictions made by the model. Generally, the global feature importance matrix represents a table in which each hyperparameter is associated with a measurement or score S_{hyperparameter} that indicates its relative importance to the decisions made during prediction by the target machine learning model.

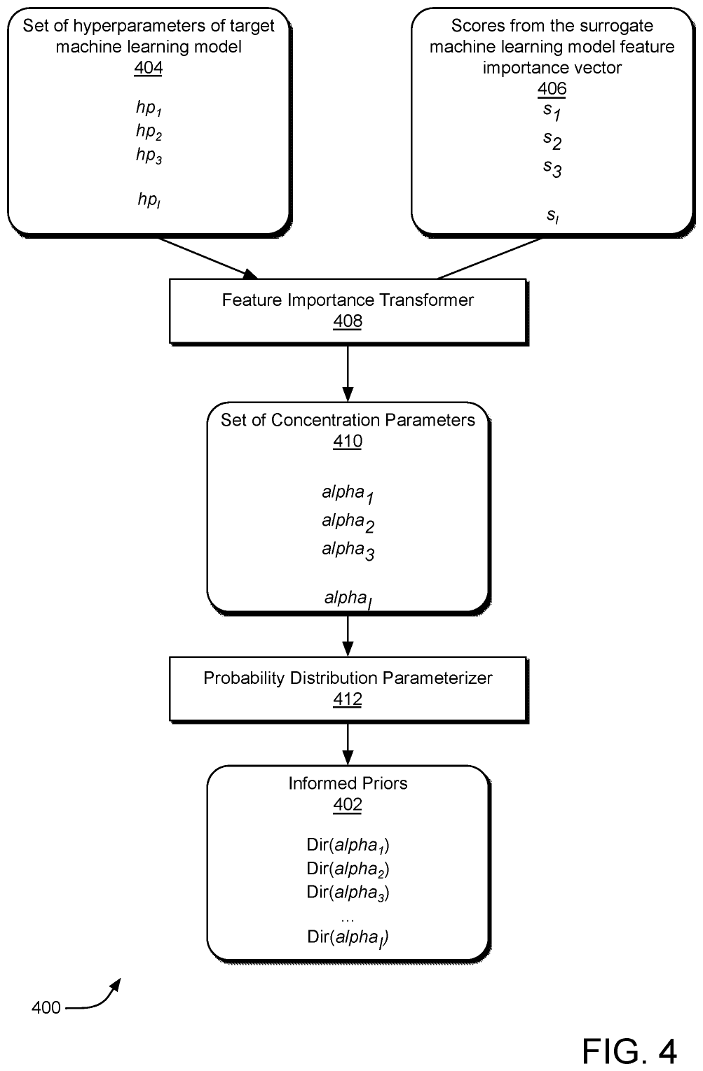

FIG. 4 illustrates an example system 400 for converting a feature importance vector of a surrogate machine learning model to informed priors 402 useful in hyperparameter tuning for a target machine learning model. In an example implementation, a dataset 404 of hyperparameters (e.g., as provided by hyperparameters and uninformed priors 306 in FIG. 3) is provided in the following format:
hp₁
hp₂
hp₃
. . .
hp_{I}
   where hpᵢ represents the ith hyperparameter in the set of I hyperparameters of the target machine learning model.

In the example implementation, an importance dataset 406 of importance scores si from the feature importance vector (e.g., as provided by the feature importance vector 328 in FIG. 3) is provided in the following format, in one implementation:
S₁
S₂
S₃
. . .
S_{I}
   where sᵢ represents the ith importance score in the set of I scores corresponding to the I hyperparameters of the target machine learning model.

The dataset 404 of hyperparameters and the importance dataset 406 of importance scores are input to a feature importance transformer 408, which extracts the feature importance scores from the feature importance vector and adjusts these scores (e.g., making them all positive, such as by shifting the scores using a positive offset or another technique) to yield an alpha dataset 410 of “concentration parameters.” In some implementations, the feature importance transformer 408 may employ an explanation tool, such as SHAP (SHapley Additive explanations), LIME (Local Interpretable Model-agnostic Explanations), or some other kind of permutation test to extract the feature importance vector. In such implementations, this shifting can be described as applying a linear transformation to the importance values sᵢ so that the smallest (potentially negative) SHAP value becomes eps>0 (where eps may be a very small number, such as 1e⁻⁶)—the resulting transformed importance values are identified as alphas, such that sᵢ corresponds to alphaᵢ. An example format of the alpha dataset 410 is provided below:
alpha₁
alpha₂
alpha₃
. . .
alpha_{I}
   where alphaᵢ represents the ith alpha in the set of I alphas corresponding to the I hyperparameters of the target machine learning model. The alphas represent positive real number parameters of a Dirichlet distribution.

A probability distribution parameterizer 412 receives the alphas from the alpha dataset 410 and applies them as parameters in a Dirichlet distribution, such that the informed priors 402 are represented as provided below:
Dir(alpha₁)
Dir(alpha₂)
Dir(alpha₃)
. . .
Dir(alpha_{I})
   where Dir(alphaᵢ) represents the ith informed prior in the set of I informed priors corresponding to the I hyperparameters of the target machine learning model. A hyperparameter tuner (e.g., the hyperparameter tuner 114 of FIG. 1) uses the informed priors 402 to tune the hyperparameter values of the target machine learning model, such as via Bayesian optimization.

Accordingly, the tuned machine learning model (see, e.g., the tuned machine learning model 104 in FIG. 1) includes tuned hyperparameter values generated from a tuning process (e.g., a Bayesian optimization or another tuning technique) based on the informed priors for each hyperparameter.

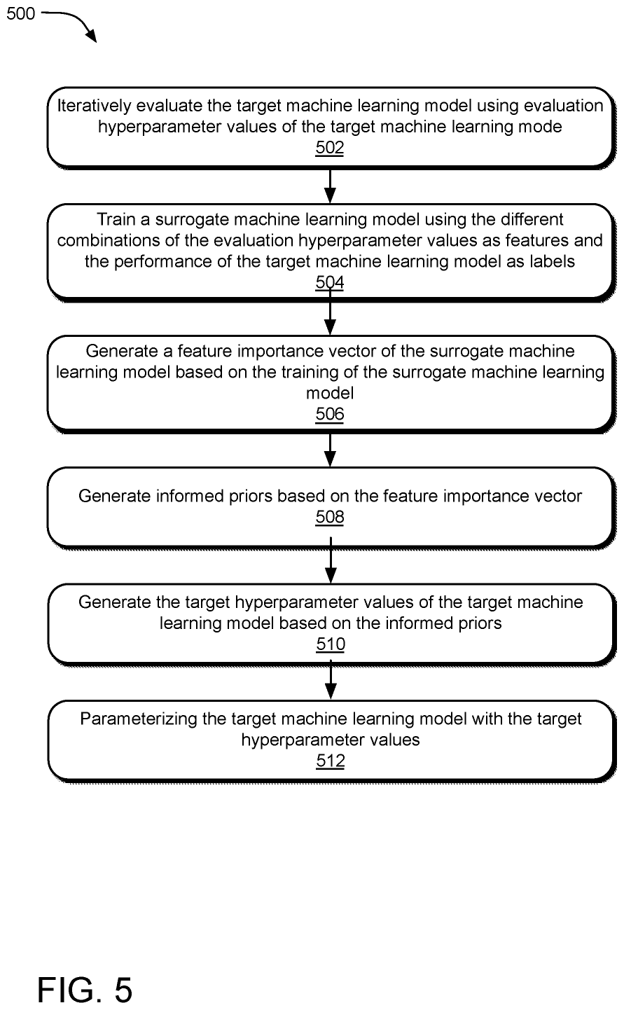

FIG. 5 illustrates example operations 500 for generating target hyperparameter values of a target machine learning model. An evaluation operation 502 iteratively evaluates the target machine learning model using the evaluation hyperparameter values of the target machine learning model. As such, the evaluation operation 502 measures the performance of the target machine learning model for different combinations of the evaluation hyperparameter values. In some implementations, the evaluation hyperparameter values are sampled from a set of predefined hyperparameter values for the target machine learning model. In some implementations, the set of predefined hyperparameter values is defined by a convex hull.

A training operation 504 trains a surrogate machine learning model using the different combinations of the evaluation hyperparameter values as features and the performance of the target machine learning model based on a corresponding combination of the evaluation hyperparameter values as labels. A feature importance operation 506 generates a feature importance vector of the surrogate machine learning model based on the training of the surrogate machine learning model.

A generating operation 508 generates informed priors based on the feature importance vector. In one implementation, generating the informed priors based on the feature importance vector includes generating, from the feature importance vector, alpha values corresponding to positive real numbers for each hyperparameter of the target machine learning model and parameterizing a Dirichlet distribution with an alpha value for each hyperparameter of the target machine learning model to yield an informed prior for each hyperparameter of the target machine learning model. Other informed prior generation techniques may be employed.

Another generating operation 510 generates the target hyperparameter values of the target machine learning model based on the informed priors using Bayesian optimization. In some implementations, a parameterizing operation 512 parameterizes the target machine learning model with the target hyperparameter values based on generating the target hyperparameter values.

In some implementations, the target machine learning model is associated with a set of training data, and the target machine learning model is trained prior to evaluating the target machine learning model using evaluation hyperparameter values, using a reduced set of training data (referred to as a reduced set of the raining data).

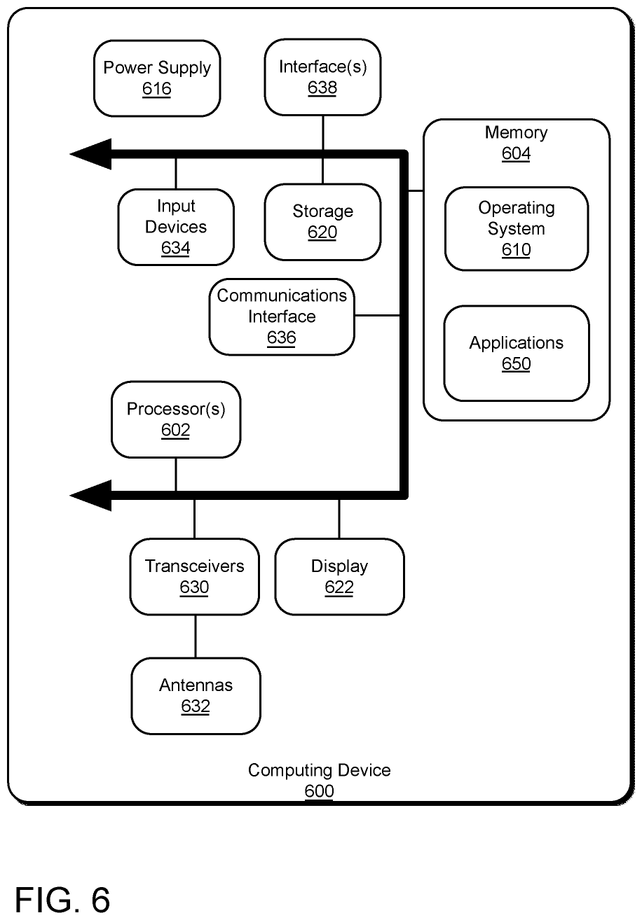

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more modules or segments, such as applications 650, machine learning models, an informed prior generator, a hyperparameter tuner, a surrogate model training subsystem, a feature importance extractor, a probability distribution parameterizer, an untuned model evaluator, training data selector, a hyperparameter value sampler, a surrogate model trainer, a feature importance transformer, and other program code and modules are loaded into the operating system 610 on the memory 604 and/or the storage 620 and executed by the processor(s) 602. The storage 620 may store a training data, informed priors, hyperparameter values, feature importance vectors, sampled hyperparameter values, listings of hyperparameters, uninformed priors, informed priors, and other data and be local to the computing device 600 or may be remote and communicatively connected to the computing device 600. In particular, in one implementation, components of a system for generating target hyperparameter values of a target machine learning model may be implemented entirely in hardware or in a combination of hardware circuitry and software.

The computing device 600 includes a power supply 616, which may include or be connected to one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of generating target hyperparameter values of a target machine learning model, the method comprising: iteratively evaluating the target machine learning model using evaluation hyperparameter values of the target machine learning model to measure performance of the target machine learning model for different combinations of the evaluation hyperparameter values, training a surrogate machine learning model using the different combinations of the evaluation hyperparameter values as features and the performance of the target machine learning model based on a corresponding combination of the evaluation hyperparameter values as labels; generating a feature importance vector of the surrogate machine learning model based on the training of the surrogate machine learning model; generating informed priors based on the feature importance vector; and generating the target hyperparameter values of the target machine learning model based on the informed priors.

Clause 2. The method of clause 1, further comprising: parameterizing the target machine learning model with the target hyperparameter values, based on generating the target hyperparameter values.

Clause 3. The method of clause 1, further comprising: sampling the evaluation hyperparameter values from a set of predefined hyperparameter values for the target machine learning model.

Clause 4. The method of clause 3, wherein the set of predefined hyperparameter values is defined by a convex hull.

Clause 5. The method of clause 1, further comprising: providing a first set of training data for the target machine learning model; reducing the first set of training data to a reduced set of training data; and training the target machine learning model using the reduced set of training data prior to evaluating the target machine learning model using the evaluation hyperparameter values.

Clause 6. The method of clause 5, further comprising: parameterizing the target machine learning model with the target hyperparameter values, based on generating the target hyperparameter values; and training the target machine learning model using the first set of training data after parameterizing the target machine learning model with the target hyperparameter values.

Clause 7. The method of clause 1, wherein generating the informed priors based on the feature importance vector comprises: generating, from the feature importance vector, alpha values corresponding to positive real numbers for each hyperparameter of the target machine learning model; and parameterizing a Dirichlet distribution with an alpha value for each hyperparameter of the target machine learning model to yield an informed prior for each hyperparameter of the target machine learning model.

Clause 8. A system for generating target hyperparameter values of a target machine learning model, the system comprising: one or more hardware processors; an untuned model evaluator executable by the one or more hardware processors and being configured to iteratively evaluate the target machine learning model using evaluation hyperparameter values of the target machine learning model to measure performance of the target machine learning model for different combinations of the evaluation hyperparameter values, a surrogate model trainer executable by the one or more hardware processors and being configured to train a surrogate machine learning model using the different combinations of the evaluation hyperparameter values as features and the performance of the target machine learning model based on a corresponding combination of the evaluation hyperparameter values as labels; a feature importance extractor executable by the one or more hardware processors and being configured to generate a feature importance vector of the surrogate machine learning model based on the training of the surrogate machine learning model; a probability distribution parameterizer executable by the one or more hardware processors and being configured to generate informed priors based on the feature importance vector; and a hyperparameter tuner executable by the one or more hardware processors and being configured to generate the target hyperparameter values of the target machine learning model based on the informed priors using Bayesian optimization.

Clause 9. The system of clause 8, wherein the target hyperparameter values of the target machine learning model generated based on the informed priors are parameterized into the target machine learning model with the target hyperparameter values.

Clause 10. The system of clause 8, wherein the evaluation hyperparameter values are sampled from a set of predefined hyperparameter values for the target machine learning model.

Clause 11. The system of clause 10, wherein the set of predefined hyperparameter values is defined by a convex hull.

Clause 12. The system of clause 8, wherein the target hyperparameter values of the target machine learning model generated based on the informed priors are parameterized into the target machine learning model with the target hyperparameter values.

Clause 13. The system of clause 8, wherein the probability distribution parameterizer is configured to generate the informed priors based on the feature importance vector by generating, from the feature importance vector, alpha values corresponding to positive real numbers for each hyperparameter of the target machine learning model, and parameterizing a Dirichlet distribution with an alpha value for each hyperparameter of the target machine learning model to yield an informed prior for each hyperparameter of the target machine learning model.

Clause 14. One or more tangible processor-readable storage media embodied with instructions for executing on one or more processors and circuits of a computing device a process for generating target hyperparameter values of a target machine learning model, the process comprising: iteratively evaluating the target machine learning model using evaluation hyperparameter values of the target machine learning model to measure performance of the target machine learning model for different combinations of the evaluation hyperparameter values, training a surrogate machine learning model using the different combinations of the evaluation hyperparameter values as features and the performance of the target machine learning model based on a corresponding combination of the evaluation hyperparameter values as labels; generating a feature importance vector of the surrogate machine learning model based on the training of the surrogate machine learning model; generating informed priors based on the feature importance vector; and generating the target hyperparameter values of the target machine learning model based on the informed priors using Bayesian optimization.

Clause 15. The one or more tangible processor-readable storage media of clause 14, wherein the process further comprises: parameterizing the target machine learning model with the target hyperparameter values, based on generating the target hyperparameter values.

Clause 16. The one or more tangible processor-readable storage media of clause 14, wherein the process further comprises: sampling the evaluation hyperparameter values from a set of predefined hyperparameter values for the target machine learning model.

Clause 17. The one or more tangible processor-readable storage media of clause 16, wherein the set of predefined hyperparameter values is defined by a convex hull.

Clause 18. The one or more tangible processor-readable storage media of clause 14, wherein the process further comprises: providing a first set of training data for the target machine learning model; reducing the first set of training data to a reduced set of training data; and training the target machine learning model using the reduced set of training data prior to evaluating the target machine learning model using the evaluation hyperparameter values.

Clause 19. The one or more tangible processor-readable storage media of clause 18, wherein the process further comprises: parameterizing the target machine learning model with the target hyperparameter values, based on generating the target hyperparameter values; and training the target machine learning model using the first set of training data after parameterizing the target machine learning model with the target hyperparameter values.

Clause 20. The one or more tangible processor-readable storage media of clause 14, wherein generating the informed priors based on the feature importance vector comprises: generating, from the feature importance vector, alpha values corresponding to positive real numbers for each hyperparameter of the target machine learning model; and parameterizing a Dirichlet distribution with an alpha value for each hyperparameter of the target machine learning model to yield an informed prior for each hyperparameter of the target machine learning model.

Clause 21. A system for generating target hyperparameter values of a target machine learning model, the method comprising: means for iteratively evaluating the target machine learning model using evaluation hyperparameter values of the target machine learning model to measure performance of the target machine learning model for different combinations of the evaluation hyperparameter values, means for training a surrogate machine learning model using the different combinations of the evaluation hyperparameter values as features and the performance of the target machine learning model based on a corresponding combination of the evaluation hyperparameter values as labels; means for generating a feature importance vector of the surrogate machine learning model based on the training of the surrogate machine learning model; means for generating informed priors based on the feature importance vector; and means for generating the target hyperparameter values of the target machine learning model based on the informed priors.

Clause 22. The system of clause 21, further comprising: means for parameterizing the target machine learning model with the target hyperparameter values, based on generating the target hyperparameter values.

Clause 23. The system of clause 21, further comprising: means for sampling the evaluation hyperparameter values from a set of predefined hyperparameter values for the target machine learning model.

Clause 24. The system of clause 23, wherein the set of predefined hyperparameter values is defined by a convex hull.

Clause 25. The system of clause 21, further comprising: means for providing a first set of training data for the target machine learning model; means for reducing the first set of training data to a reduced set of training data; and means for training the target machine learning model using the reduced set of training data prior to evaluation of the target machine learning model using the evaluation hyperparameter values.

Clause 26. The system of clause 25, further comprising: means for parameterizing the target machine learning model with the target hyperparameter values, based on generating the target hyperparameter values; and means for training the target machine learning model using the first set of training data after parameterizing the target machine learning model with the target hyperparameter values.

Clause 27. The system of clause 21, wherein the means for generating the informed priors based on the feature importance vector comprises: means for generating, from the feature importance vector, alpha values corresponding to positive real numbers for each hyperparameter of the target machine learning model; and means for parameterizing a Dirichlet distribution with an alpha value for each hyperparameter of the target machine learning model to yield an informed prior for each hyperparameter of the target machine learning model.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of generating target hyperparameter values of a target machine learning model, the method comprising:
iteratively evaluating the target machine learning model using evaluation hyperparameter values of the target machine learning model to measure performance of the target machine learning model for different combinations of the evaluation hyperparameter values,
training a surrogate machine learning model using the different combinations of the evaluation hyperparameter values as features and the performance of the target machine learning model based on a corresponding combination of the evaluation hyperparameter values as labels;
generating a feature importance vector of the surrogate machine learning model based on the training of the surrogate machine learning model;
generating informed priors based on the feature importance vector; and
generating the target hyperparameter values of the target machine learning model based on the informed priors.

2. The method of claim 1, further comprising:
parameterizing the target machine learning model with the target hyperparameter values, based on generating the target hyperparameter values.

3. The method of claim 1, further comprising:
sampling the evaluation hyperparameter values from a set of predefined hyperparameter values for the target machine learning model.

4. The method of claim 3, wherein the set of predefined hyperparameter values is defined by a convex hull.

5. The method of claim 1, further comprising:
providing a first set of training data for the target machine learning model;
reducing the first set of training data to a reduced set of training data; and
training the target machine learning model using the reduced set of training data prior to evaluating the target machine learning model using the evaluation hyperparameter values.

6. The method of claim 5, further comprising:
parameterizing the target machine learning model with the target hyperparameter values, based on generating the target hyperparameter values; and
training the target machine learning model using the first set of training data after parameterizing the target machine learning model with the target hyperparameter values.

7. The method of claim 1, wherein generating the informed priors based on the feature importance vector comprises:
generating, from the feature importance vector, alpha values corresponding to positive real numbers for each hyperparameter of the target machine learning model; and
parameterizing a Dirichlet distribution with an alpha value for each hyperparameter of the target machine learning model to yield an informed prior for each hyperparameter of the target machine learning model.

8. A system for generating target hyperparameter values of a target machine learning model, the system comprising:
one or more hardware processors;
an untuned model evaluator executable by the one or more hardware processors and being configured to iteratively evaluate the target machine learning model using evaluation hyperparameter values of the target machine learning model to measure performance of the target machine learning model for different combinations of the evaluation hyperparameter values,
a surrogate model trainer executable by the one or more hardware processors and being configured to train a surrogate machine learning model using the different combinations of the evaluation hyperparameter values as features and the performance of the target machine learning model based on a corresponding combination of the evaluation hyperparameter values as labels;
a feature importance extractor executable by the one or more hardware processors and being configured to generate a feature importance vector of the surrogate machine learning model based on the training of the surrogate machine learning model;
a probability distribution parameterizer executable by the one or more hardware processors and being configured to generate informed priors based on the feature importance vector; and
a hyperparameter tuner executable by the one or more hardware processors and being configured to generate the target hyperparameter values of the target machine learning model based on the informed priors using Bayesian optimization.

9. The system of claim 8, wherein the target hyperparameter values of the target machine learning model generated based on the informed priors are parameterized into the target machine learning model with the target hyperparameter values.

10. The system of claim 8, wherein the evaluation hyperparameter values are sampled from a set of predefined hyperparameter values for the target machine learning model.

11. The system of claim 10, wherein the set of predefined hyperparameter values is defined by a convex hull.

12. The system of claim 8, wherein the target hyperparameter values of the target machine learning model generated based on the informed priors are parameterized into the target machine learning model with the target hyperparameter values.

13. The system of claim 8, wherein the probability distribution parameterizer is configured to generate the informed priors based on the feature importance vector by generating, from the feature importance vector, alpha values corresponding to positive real numbers for each hyperparameter of the target machine learning model, and parameterizing a Dirichlet distribution with an alpha value for each hyperparameter of the target machine learning model to yield an informed prior for each hyperparameter of the target machine learning model.

14. One or more tangible processor-readable storage media embodied with instructions for executing on one or more processors and circuits of a computing device a process for generating target hyperparameter values of a target machine learning model, the process comprising:
iteratively evaluating the target machine learning model using evaluation hyperparameter values of the target machine learning model to measure performance of the target machine learning model for different combinations of the evaluation hyperparameter values,
training a surrogate machine learning model using the different combinations of the evaluation hyperparameter values as features and the performance of the target machine learning model based on a corresponding combination of the evaluation hyperparameter values as labels;
generating a feature importance vector of the surrogate machine learning model based on the training of the surrogate machine learning model;
generating informed priors based on the feature importance vector; and
generating the target hyperparameter values of the target machine learning model based on the informed priors using Bayesian optimization.

15. The one or more tangible processor-readable storage media of claim 14, wherein the process further comprises:
parameterizing the target machine learning model with the target hyperparameter values, based on generating the target hyperparameter values.

16. The one or more tangible processor-readable storage media of claim 14, wherein the process further comprises:
sampling the evaluation hyperparameter values from a set of predefined hyperparameter values for the target machine learning model.

17. The one or more tangible processor-readable storage media of claim 16, wherein the set of predefined hyperparameter values is defined by a convex hull.

18. The one or more tangible processor-readable storage media of claim 14, wherein the process further comprises:
providing a first set of training data for the target machine learning model;
reducing the first set of training data to a reduced set of training data; and
training the target machine learning model using the reduced set of training data prior to evaluating the target machine learning model using the evaluation hyperparameter values.

19. The one or more tangible processor-readable storage media of claim 18, wherein the process further comprises:
parameterizing the target machine learning model with the target hyperparameter values, based on generating the target hyperparameter values; and
training the target machine learning model using the first set of training data after parameterizing the target machine learning model with the target hyperparameter values.

20. The one or more tangible processor-readable storage media of claim 14, wherein generating the informed priors based on the feature importance vector comprises:
generating, from the feature importance vector, alpha values corresponding to positive real numbers for each hyperparameter of the target machine learning model; and
parameterizing a Dirichlet distribution with an alpha value for each hyperparameter of the target machine learning model to yield an informed prior for each hyperparameter of the target machine learning model.
